(19) United States
(12) Patent Application Publication
(10) Pub. No.: US 2023/0015556 A1
(43) Pub. Date: Jan. 19, 2023

(54) LIGHTWEIGHT DATA STORAGE APPARATUS FOR GRAPHIC BLOCKCHAIN AND METHOD THEREOF

(71) Applicant: Huazhong University of Science and Technology, Wuhan City (CN)

(72) Inventors: Jiang XIAO, Wuhan City (CN); Xiaohai DAI, Wuhan City (CN); Shijie ZHANG, Wuhan City (CN); Hai JIN, Wuhan City (CN)

(21) Appl. No.: 17/664,750

(22) Filed: May 24, 2022

(30) Foreign Application Priority Data
Jul. 13, 2021 (CN) 202110792745.6

(51) Int. Cl. H04L 9/00; H04L 9/40; G06Q 20/38

(52) U.S. Cl. CPC H04L 9/50; H04L 9/40; G06Q 20/382; H04L 2209/56

(57) ABSTRACT

The present invention relates to a lightweight data storage apparatus for graphic blockchains, at least comprising a common transaction construction module for a user to initiate new transactions and a network broadcast module for broadcasting the transactions, wherein the apparatus further comprises a combined-transaction constructing module and a transaction deleting module, wherein the combined-transaction constructing module serves to determine whether number of transactions initiated by an account satisfies a first predetermined condition, and if yes, execute a first lightening procedure on the transactions, and the transaction deleting module serves to execute a second lightening procedure on the transactions that have been processed by the first lightening procedure and now have validation references satisfying a second predetermined condition, after which the network broadcast module broadcasts the transactions obtained after the second lightening procedure. With the disclosed transaction-combining and reference-transaction-deleting scheme, data storage overheads of a graphic blockchain can be reduced.

This application claims the benefit of the Chinese Patent Application No. CN 202110792745.6 filed on Jul. 13, 2021, which is hereby incorporated by reference as if fully set forth herein.

### BACKGROUND OF THE INVENTION

### 1. Technical Field

The present invention relates to the technical field of blockchains, and more particularly to a lightweight data storage apparatus for graphic blockchains and a method thereof.

### 2. Description of Related Art

With the advantages of tamper-proofing, transparency and traceability, the blockchain technology is expected to be a trustable footstone for reshaping public governance and commercial logics. Also, these advantages make the blockchain technology extensively applied in diverse scenarios, such as cryptocurrencies, data provenance, and trusted storage. The traditional link-type blockchain models stemmed from a model designed for the underlying technology of Bitcoins by Satoshi Nakamoto. The core principle is using the uniqueness of miners (bookkeeping rights) to ensure the uniqueness of valid data chains. The basic unit in a link-type blockchain system is a block. Blocks are connected through Hash pointers, which ensure the integrity, continuity, and validity of data. A block is composed of a block header and a block body. A block is generated by a miner who collects transactions in a certain period of time and packets the transactions. The packet is then combined with a timestamp and encapsulated by means of asymmetric encryption. At last, the miner broadcasts the block to other users. A user receiving the block tries to extend and complete local data. Inheriting the properties of Bitcoins in genesis projects, most blockchain systems adopt chronological-sequence-based data models. In such a data model, a subsequent block contains Hash of its previous block. While the link-type data structure helps protect transaction from being maliciously tampered, it compromises the blockchain system in terms of performance. For example, as the currently dominant blockchain platforms, the Bitcoin and Ethereum systems can only process 7 and 15 transactions per second, respectively.

A linked list is a chain formed by numerous peer links. Every peer contains a link pointing to its previous peer. The reason why a blockchain can be formed is that every new block has a pointer pointed at its previous block, and this endows a blockchain with a data structure in the form of a linked list. However, being a link is just where the problem of blockchains lies. Assuming that the time for generating a block is constant, the line-like structure can cause performance bottleneck because only one block can be added to the chain in the set interval. Therefore, efforts to improve performance of blockchains may be made in two aspects. One is to shorten the time required for generating a block. The other is to allow parallel additions of new data by using the DAG technology to change the data structure.

As compared to link-type blockchains, blockchains based on DAGs (Directed Acyclic Graphs) have superior scalability. Link-type blockchains can only organize data into a link, and any fork will be regarded invalid. The uniqueness of write access to a database and the single-directional extension of data make link-type blockchains significantly limited in terms of scalability and concurrency. As to the way how data are organized, a DAG-based blockchain allows every block to have two or more Hash pointers, so blocks generated in a certain period of time can form a directed acyclic graph. As to write access, a DAG-base blockchain allows multiple users (even every user) to have write access. The generator of one block can autonomously select to refer several historical blocks and broadcast them. Users receiving the blocks then keep them in its local database. Improvements in these two aspects result in significant enhancement of DAG-based blockchains in terms of scalability and concurrency.

DAG-based blockchains represent a distributed ledger technology different from the dominant blockchain types for their capability of asynchronous accounting, opposite to the conventional, synchronous accounting. Current, efficiency is the major technical issue that restricts the development of blockchains, and the DAG-based solution gives the opportunity to make blockchains more efficient. The DAG technology has primarily addressed three demands from users for a desired blockchain system. The first one is transaction velocity. Opposite to a blockchain that can only process transactions with a single thread, a DAG allows multi-thread transaction processing, and more dealers in a DAG result in faster processing. Secondarily, a DAG-based system saves additional handling fees as it directly delegates the environment in which transactions are confirmed to the transactions themselves. Thirdly, it saves resources because there is not any miner in a DAG, and thus no social resources are consumed. For enhancing performance, some blockchain projects have introduced a directed acyclic graph (DAG) structure as the basic data model. Such a model is expected to be powerful in parallel transaction processing and validation. Factors determine performance of a traditional blockchain include the block size, the block generation rate, and the transaction confirmation rate. Different from traditional blockchains, a DAG-based chain is not constructed from blocks and thus is not limited to the capacity of blocks. A TX (transaction) is regarded as a message, and plural messages form a data block. A data block is also known as a unit. A DAG is formed by having units linked together. A blockchain has a single thread, and a DAG has multiple threads. As to transaction validation, a new unit may be selectively linked to any one or more old units, and the new transaction is validated by referring old transactions, which is called “DAG consensus”. This allows temporary, tiny differences to be exist among ledgers of users. By weakening the consistency across a network in a very short period of time, network congestion can be reduced and transaction concurrency can be improved. Therefore, in a DAG-chain network, the larger the size of peers is, the larger the transaction amount is, and the shorter the time for confirming transactions is.

In general, DAG-based blockchain systems may be divided into two types, namely blockDAGs and txDAGs. The first type (e.g., Conflux and the Phantom consensus algorithms), similar to the traditional link-type blockchains, organizes and processes multiple transactions in the unit of blocks. Theoretically, this allows different peers to create new blocks parallelly, thereby increasing system throughput. However, in practical operation, blocks concurrently generated may contain a huge amount of transaction overlap, and limit performance improvement. By contrast, txDAGs, including IOTA, Byteball, Nano, and other projects, use a more fine-grained unit for storage, namely “transactions”, so as to achieve higher parallelism, and thus are popular for graphic blockchain projects.

In the prior art, Patent Application Publication No. CN111080288A discloses a blockchain consensus achieving method based on a directed acyclic graph and a device thereof, wherein the method comprises the following steps: when a network node on a blockchain issues a certain transaction, creating a new block corresponding to the certain transaction in a current DAG view, and updating an axis tree in the current DAG view and the current DAG view according to the new block and a rule of an optimal axis tree; and according to the PBFT algorithm, enabling the whole network of the blockchain to achieve consensus on the axis tree of the updated DAG view, thereby the processing efficiency of the blockchain system can be improved on the premise of ensuring decentralization and safety.

The prior-art Patent Application Publication No. CN111901350A discloses a blockchain system, a data processing method, and corresponding computer equipment and storage medium, and belongs to the technical field of blockchains. The data processing method of the blockchain improves the storage efficiency of the block by constructing the blockchain with the directed acyclic graph structure, compresses the data stored in the block, and effectively improves the storage space of the block; the data are transmitted in a polymerization mode, so that the network communication efficiency of the blockchain is improved; the transaction information in each node is synchronized by adopting a POA protocol, thereby reducing the verification complexity and accelerating the consensus verification efficiency among the nodes; and a side chain protocol and a fragmentation strategy are adopted to control data interaction between the blocks, so as to improve the interaction efficiency between the blocks.

However, while the existing txDAG graphic blockchain projects improve system performance, they bring about huge overheads for data storage. More precisely, storage overheads form a more serious issue with txDAG projects than with blockDAG graphic blockchain projects and link-type blockchain projects. This is because a txDAG system requires every transaction to include additional Hash fields for referring past transactions. These transaction fields often take great storage space. Specifically, a Hash field is usually larger than other fields. For example, the former many need 32 bytes, and the later, such as a random number, only takes 8 bytes or even 4 bytes. Therefore, a txDAG system tends to accumulate data up to one TB (Terabyte) or more, which is much larger than the storage capacity of a normal peer. Particularly, in scenarios where device resources are limited, like in the Internet of Things (IoT), the huge storage overheads imposed on peers form a pressing problem to be solved.

Further, since there is certainly discrepancy between the prior art comprehended by the applicant of this patent application and that known by the patent examiners and since there are many details and disclosures disclosed in literatures and patent documents that have been referred by the applicant during creation of the present invention not exhaustively recited here, it is to be noted that the present invention shall actually include technical features of all of these prior-art works, and the applicant reserves the right to supplement the application with technical features known in the art as support.

### SUMMARY OF THE INVENTION

The known lightweight data storage schemes for blockchain systems are generally focused on a link-type blockchain structure. In a link-type blockchain system, since the transaction frequency is relatively low, redundancy of account data is less. Besides, transactions in a link-type blockchain system do not have to refer each other, so redundancy of reference data is not a problem. On the contrary, in a graphic blockchain, particularly a txDAG graphic blockchain, since the storage unit is such fine-grained as a “transaction”, high parallelism can be achieved and lead to improved system performance, but the resulting data storage overheads are considerable. In brief, a graphic blockchain suffers from serious redundancy of both account data and reference data. To solve this problem, the present invention provides a lightweight data storage apparatus and a lightweight data storage method applicable to graphic blockchains. The present invention can be also understood as a graphic-blockchain-orientated, flexible and scalable data storage model and a system using the model, which feature high scalability in graphic blockchains. The inventor of the present invention analyzed data redundancy in graphic blockchain systems and has identified two problems, namely account data redundancy and reference data redundancy. To solve the problems, the present invention provides a periodic transaction-combining scheme that reduces redundancy of account data. The scheme is also about reducing redundancy of reference data by deleting references and transactions that have been overridden according to analysis of override relationship among reference data. With the disclosed transaction-combining and reference-transaction-deleting scheme, data storage overheads of a graphic blockchain can be reduced.

The present invention provides a lightweight data storage apparatus for graphic blockchains, at least comprising a common transaction construction module for a user to initiate new transactions and a network broadcast module for broadcasting the transactions, wherein the apparatus further comprises a combined-transaction constructing module and a transaction deleting module, wherein the combined-transaction constructing module serves to determine whether number of transactions initiated by an account satisfies a first predetermined condition, and if yes, execute a first lightening procedure on the transactions, and the transaction deleting module serves to execute a second lightening procedure on the transactions that have been processed by the first lightening procedure and now have validation references satisfying a second predetermined condition, after which the network broadcast module broadcasts the transactions obtained after the second lightening procedure. The first lightening procedure refers to combining transactions. The second lightening procedure refers to deleting transactions.

According to a preferred embodiment, the combined-transaction constructing module is configured to periodically determine whether the number of the transactions initiated by the account satisfies the first predetermined condition for combination.

According to a preferred embodiment, the lightweight data storage apparatus further comprises a common transaction construction module that serves to construct data of new transaction initiated by the user.

According to a preferred embodiment, the combined-transaction constructing module is for collecting at least one previous transaction prior to the construction of the new transaction and combining the at least one previous transaction being collected with the recently constructed new transaction.

According to a preferred embodiment, the combined-transaction constructing module is configured to generate at least one of the followings for the combined transaction through the first lightening procedure: content site, header site, validation site, and signature site.

According to a preferred embodiment, further comprising a content site compressing module, which serves to uniformly store the content sites in the different combined transactions associated with the same account.

This disclosure further provides a lightweight data storage method for graphic blockchains, the method at least comprising: determining whether number of transactions initiated by an account satisfies a first predetermined condition; executing a combining procedure on the transactions, when the number of transactions satisfies the first predetermined condition; determining whether validation references of the transactions satisfy a second predetermined condition; executing a deleting procedure on the transactions, when the validation references satisfy the second predetermined condition; and broadcasting the combined transactions.

According to a preferred embodiment, the lightweight data storage method further comprises periodically determining whether the number of the transactions initiated by the account satisfies the first predetermined condition for combination.

According to a preferred embodiment, the first predetermined condition includes: the current number of the transactions initiated by the account is an integer multiple of a predetermined threshold for the number of transactions.

According to a preferred embodiment, the lightweight data storage method further comprises combining at least two of the transactions initiated by the account corresponding to the predetermined threshold for the number of transactions and obtaining a combined transaction.

According to a preferred embodiment, the step of combining transactions at least comprises: combining validation references of individual transactions so as to construct a validation site in a combined transaction.

According to a preferred embodiment, the second predetermined condition includes: at least one transaction in the combined transaction has reached a reference override state.

According to a preferred embodiment, the step of deleting transactions at least comprises: deleting validation reference data of transactions that have reached the reference override state.

According to a preferred embodiment, if the number of transactions initiated by an account does not satisfy the first predetermined condition, the account constructs a common transaction, and broadcasts the common transaction.

The present invention further provides a lightweight data storage apparatus applicable to graphic blockchains, which at least comprises a common transaction construction module for users to initiate new transactions, the apparatus further comprising: a combined-transaction constructing module, being configured to collect at least one transaction initiated by the account previously, and combine relevant fields in the at least one transaction initiated by the account previously with relevant fields in a new transaction; a reference override computing module, for computing override relationship of validation references contained in the new transaction; and a transaction deleting module, for deleting transactions that have reached the reference override state.

The present invention further provides a lightweight data storage apparatus applicable to graphic blockchains, which comprises a computer device, wherein the computer device is programmed or configured to execute steps of the disclosed lightweight data storage method applicable to graphic blockchains. Alternatively, the computer device may have a storage medium storing therein a computer program which is programmed or configured to execute the disclosed lightweight data storage method applicable to graphic blockchains. Alternatively, a computer readable storage medium stores therein a computer program programmed or configured to execute the disclosed lightweight data storage method applicable to graphic blockchains.

The technical schemes of the present invention can at least provide one of the following beneficial effects:

(1) In the present invention, a lightweight data storage model designed for graphic blockchains is expected to significantly reduce data storage overheads of a blockchain system, and enhance scalability of the system. Meanwhile, the model preserves the intact parallelism of the graphic blockchain system, thereby ensuring desired system throughput. Additionally, the model has no adverse effects on the accumulated consensus confirmation algorithm adopted by the graphic blockchain system, thereby maintaining the intact security level of a graphic blockchain system.

(2) The present invention provides a lightweight data storage model designed for graphic blockchains, which may be taken as a reference for blockchain data storage models of other structures. Such as blockchain systems of the traditional link-type structure and for graph-link-hybrid blockchain systems to be developed in the future. The transaction combining and deleting method provided by present invention is expected to reduce data storage overheads of the system.

### BRIEF DESCRIPTION OF THE DRAWINGS

FIG. 1 is a schematic flowchart of a lightweight data storage method for graphic blockchains according to the present invention.

### DETAILED DESCRIPTION OF THE INVENTION

The present invention will be further detailed below with reference to accompanying drawings and particular embodiments for further explaining its objectives, technical schemes and advantages. It is to be understood that these embodiments are only illustrative but not limiting. Moreover, the technical features referred to in the embodiments of the present invention may be combined with each other in any manner as long as no conflicts are caused therebetween.

For ease of understanding, technical terms of the present invention are explained as follows.

A DAG, or a directed acyclic graph is mathematically defined as a directed finite graph that does not have any directed loop. It is composed of a finite number of apexes and directed edges. Every directed edge is pointed at an apex from another apex. A travel started from any apex through these directed edges will never go back to the departure apex. In the field of computer science, a directed acyclic graph is a data structure, or a way how data are organized.

A graphic blockchain mainly refers to a DAG-based blockchain, also known as a DAG ledger. It uses a DAG data structure to organize and store ledger data. Every apex in a DAG ledger represents a storage unit, which may be a single transaction, or a block composed of multiple transactions happening in a period of time. A normal single-chain blockchain is a special case of a DAG ledger, which means that, in every period of time, the whole system can only generate one block. What is different is, a DAG ledger allows different peers to create storage units at their own paces, as long as every storage unit selects one or more units as its sub-units. A DAG ledger has obvious advantages over the traditional link-type blockchains, mainly in terms of scalability and transaction throughput. By organizing a ledger using the DAG data structure, a peer can process new transactions without having data consistency of all peers. This prevents time waste caused by network latency and data synchronization. Therefore, the number of peers participating in DAG accounting can significantly increase. Additionally, the DAG ledger may be tailed with any amount of new data in a parallel manner, so it naturally has high concurrency to provide excellent transaction throughput. This makes it beat link-type blockchains. A link-type blockchain only allows one-block-sized data to be added, so its transaction throughput is limited and hard to be significantly improved.

Herein, flexibility, or scalability, means the ability to process an increased number of transactions in a given period of time by means of some technology or protocol. For example, a traditional payment network, like Visa, can process thousands of transactions every second, but most blockchains can only process a few transactions in the same duration.

A blockchain is maintained by a group of peers having consensus protocols (Proof of Work, Proof of Stake, and Delegated Proof of Stake). Every peer keeps a local copy of the whole blockchain. Thus, every peer can access the historical information, search the transactions and calculate the balance. However, as the amount of data contained in a blockchain increase, the required storage space also increases. For example, some complete digital credential block is composed of a block header and a block body, wherein the block header takes up 80 bytes and contains the basic information about the block, such as the version, the block header Hash value of the previous block, the Merkle root Hash, the timestamp, the target value, and a random number. The block body contains transaction data. The transaction data contained in the block body are used to construct a Merkle tree, whose root is stored in the block head. Every transaction is signed by its sender using a digital signature, so as to ensure that the transaction cannot be counterfeited. A transaction includes several transaction inputs and several transaction outputs. Every input in a transaction corresponds to the output of some prior transaction, and is expressed as a Hash pointer, which takes up 32 bytes, and called the previous tx hash. Since every transaction has at least one input, and the size of the Hash field is usually greater than any other field (such as requiring 32 bytes for the Hash field, and 8 bytes or 4 bytes for the random number), the Hash pointers occupy a large space in a block.

In order to reduce data storage overheads of a graphic blockchain system, the present invention provides a lightweight data storage method applicable to graphic blockchains. The method at least comprises steps S1 to S10. While the steps of the lightweight data storage method are herein described in a specific sequence, this shall not be construed as that the exact operations have to be performed in the described sequence or performed successively to obtain the expected results. In some cases, multi-tasking or parallel processing may be advantageous. Similarly, the detailed implementation included in the discussion given above shall not be interpreted as limitations to the scope of the present invention or of the claims. Instead, they are only description for some particular embodiments of the discussed invention. In the disclosure, some features separately described with respect to the context of different embodiments may be integrally implemented in a single embodiment. On the contrary, features described with respect to the context of a single embodiment may be alternatively implemented in multiple embodiments or any suitable sub-combination of these embodiments separately.

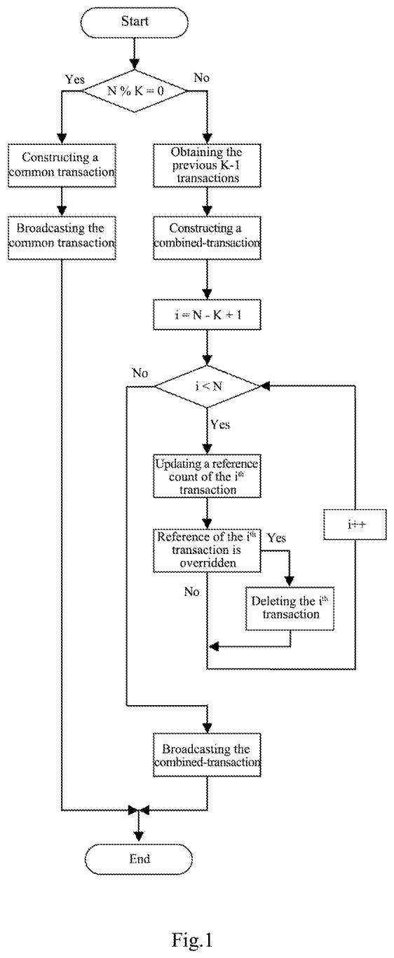

At the step S1, for N^{th} transactions initiated by an account, it is determined whether N is an integer multiple of K. The determination corresponds to the first predetermined condition. As shown in FIG. 1, N % Y=0, this is equivalent to that N is divisible by Y, or N is an integer multiple of Y. If N % Y==0 is true, the method turns to the step S2. Otherwise, the method turns to the step S3. The transactions are combined according to a certain cycle, so as to prevent computing overheads caused by frequent computation. Without losing generality, the cycle is set as K transactions. In other words, after initiating every K transaction, the account tries to perform combination once. In the disclosure, the value of K is a predetermined threshold for the number of transactions.

At S2, the account constructs a common transaction T_{N}, and broadcasts the common transaction.

Preferably, the common transaction T_{N} includes a parent reference field, two validation reference fields, a sending-party account field, a receiving-party account field, a transfer amount field, a timestamp field, a random number field, and a signature field. Therein, the parent reference field is pointed at the previous transaction Hash sent by the account, and the validation reference field is randomly pointed at two end-point peer transaction Hashes in the network.

Preferably, in order to ensure the common transactions can be combined in a later stage, the step S2 may further comprises: if a transaction has not been used referred by any other transaction by means of the validation reference field, determining that the transaction is an end-point peer transaction. Generally speaking, end-point peer transactions are some newly generated transactions. In addition, since different accounts have different network views, and a network has a certain latency, it is possible that different accounts refer the same end-point peer transaction at the same time.

At S3, the N^{th} transaction that meets the combination cycle, combining the K−1 transactions prior to it. That is, the K−1 transactions: T_{N-K+1}, T_{N-K+2}, . . . , T_{N-1} initiated by the account previously are acquired and combined into TU_{N}.

Preferably, for reducing data storage overheads for the combined transactions, the step S3 may further comprises at least one of S31 to S34.

At S31, according to the significance of transaction contents, the contents of every transaction can be divided into two types, namely core contents and auxiliary contents. Therein, the core contents include fields related to the transaction, such as the receiving party account, the transfer amount, the timestamp, and the random number. The auxiliary contents include fields of the parent reference and the validation reference. For every transaction of T_{N-K+1}, T_{N-K+2}, . . . , T_{N-1}, T_{N}, its core contents are preserved in the combined transaction, so as to form a core content site of the combined transaction.

At S32, the parent reference in the auxiliary contents is such processed that the parent references of the T_{N-K+1} transactions and the current account forms a header site of the combined transaction.

At S33, the validation reference in the auxiliary contents is such processed that the validation references of the T_{N-K+1}, T_{N-K+2}, . . . , T_{N-1}, T_{N} are combined into a validation site of the combined transaction.

To multiple combined transactions published by the same account, data in the content sites and different combined transactions are likely to be duplicate. At S34, the data in the core content site of the combined transaction are uniformly stored in a common content site (CCS), and for every combined transaction, pointers pointed at different parts of the CCS are generated to indicate the number of the content sites of the combined transaction.

At S34, the whole combined transaction is signed by tailing the combined transaction with a signature.

At S4, it is set that i=N−K+1. At this time, i corresponds to the (N−K+1)^{th} transaction T_{N-K+1}.

S5 is about determining whether i<N according to the second predetermined condition. If i<N is true, the method turns to the step S6. Otherwise, the method turns to the step S10.

At S6, the reference count of the i^{th} transaction is updated. Specifically, if a new transaction refers some prior transaction, 1 is added to the reference count of the referred transaction. Updating the reference count of the i^{th} transaction is to ensure that the referred object exists. This does not affect the accumulated consensus confirmation algorithm adopted by the graphic blockchain system.

At S7, it is to determine whether the validation reference of the prior i^{th} transaction has reached the state of “reference override”, and to further cut the data in the validation site of the combined transaction accordingly. If yes, the method turns to the step S8. If not, the method turns to the step S9.

Preferably, to any two validation references, if their header peers and tail peers of a reference belong to the same accounts, respectively, this is the case that the validation reference having the later timestamp overrides the validation reference having the earlier timestamp. If all validation references in a transaction are overridden, it is the case that the transaction reaches a state of “reference override”.

At S8, the i^{th} transaction is deleted to reduce the storage space occupied by the data.

At S9, the value of i is increased progressively. The method then turns to the step S5 for processing the next transaction. By increasing the value of i progressively, the K transactions in the current transaction cycle can be traversed. As shown in FIG. 1, i++ is equivalent to increasing the value of i progressively.

At S10, TU_{N} is broadcasted. The method ends.

Preferably, to lower the network transmission overheads for broadcasting a TU, the current user just needs to broadcast the respective fields such as the receiving-party account, the transfer amount, the timestamp, the random number, and the validation reference in the new transaction, as well as the signature field of the new TU. When other users receive the foregoing field information, they can construct the full contents of the TU (combined transaction) based on the existing transaction data.

The disclosed lightweight data storage apparatus for graphic blockchains at least comprises at least one of the following modules: a common transaction construction module, a combined-transaction constructing module, a reference count updating module, a reference override computing module, a transaction deleting module, a content site compressing module, and a network broadcast module. Preferably, the lightweight data storage apparatus of the present invention may be, for example, a computer, a server, or another device or system using the lightweight data storage apparatus. According to embodiments of the present invention, besides the common transaction construction module, the combined-transaction constructing module, the reference count updating module, the reference override computing module, the transaction deleting module, the content site compressing module, and the network broadcast module, the shard-type storage apparatus may further comprise other components, such as a central processor, a communication unit, a storage unit or an I/O unit. For example, the common transaction construction module, the combined-transaction constructing module, the reference count updating module, the reference override computing module, the transaction deleting module, the content site compressing module, and the network broadcast module are connected with the central processing unit, respectively, and all perform information exchange with it. Alternatively, the common transaction construction module, the combined-transaction constructing module, the reference count updating module, the reference override computing module, the transaction deleting module, the content site compressing module, and the network broadcast module are successively connected with each other to perform information exchange.

As examples, a general-purpose processor, a digital signal processor (DSP), an application specific integrated circuit (ASIC), a field programmable gate array (FPGA) or another programmable logic device, a discrete gate or transistor logic, a discrete hardware component and/or any combination for executing the disclosed functions may be used to realize or implement the various exemplary logic blocks, modules, and circuits as described herein. The general-purpose processor may be a micro-processor. Alternatively, the processor may be any ordinary processor, controller, micro-controller or state machine. The processor may alternatively be realized as a combination of computing equipment, such as a combination of DSP and a micro-processor, a combination of plural micro-processors, a combination of one or plural micro-processors and a DSP kernel, or any other similar structure. As examples, the disclosed embodiment may be described in the context of a machine-executable instruction. The machine-executable instruction may be incorporated in a program module operating in a device on the actual or virtual target processor. Generally speaking, the program module may include a routine, a program, a library, an object, a class, a component, a data structure, etc., and is for executing particular tasks or realizing particular abstract data structures. In individual embodiments, functions of the program module may be merged or divided among the described program modules. The machine-executable instruction used in the program module may be executed locally or in distributed equipment. In the distributed equipment, the program module may be located both locally and in a remote storage medium.

The common transaction construction module is used when a user initiates a new transaction. The common transaction construction module constructs transaction data when there is no need to combine transactions. Constructing the transaction data includes signing the generated new transaction.

The combined-transaction constructing module is used to collect the K−1 transactions initiated by the account before. The combined-transaction constructing module combines related fields in the K−1 transactions and in the new transaction. The combined-transaction constructing module generates the content site, the header site, the validation site, and the signature site in the combined transaction.

A reference count updating module is used to update the reference count with respect to the other peers pointed by the new transaction.

A reference override computing module is used to compute the override relationship of the validation reference contained in the new transaction. The reference override computing module can mark the overridden validation references.

The transaction deleting module serves to delete a transaction whose all validation references have all been overridden, thereby reducing data storage overheads in the system.

The content site compressing module is for uniformly storing the content sites of the different combined transactions of the same account. The data redundancy in the combined transactions are compressed so as to effectively reduce data storage overheads.

The network broadcast module is used to collect the respective fields such as receiving-party account, the transfer amount, the timestamp, the random number, the validation reference in the new transaction, and the signature field in the new TU. The network broadcast module then uses these fields to construct a TU augmentation, thereby realizing lightweight network broadcast.

It should be noted that the above-mentioned specific embodiments are exemplary, and those skilled in the art can come up with various solutions inspired by the disclosure of the present invention, and those solutions also fall within the disclosure scope as well as the protection scope of the present invention. It should be understood by those skilled in the art that the description of the present invention and the accompanying drawings are illustrative rather than limiting to the claims. The protection scope of the present invention is defined by the claims and their equivalents. The description of the present invention contains a number of inventive concepts, such as “preferably”, “according to a preferred embodiment” or “optionally” all indicate that the corresponding paragraph discloses an independent idea, and the applicant reserves the right to file a divisional application based on each of the inventive concepts.

What is claimed is:

1. A lightweight data storage apparatus for graphic blockchains, the apparatus at least comprising a common transaction construction module for a user to initiate new transactions and a network broadcast module for broadcasting the transactions, wherein
the lightweight data storage apparatus further comprises a combined-transaction constructing module and a transaction deleting module, wherein the combined-transaction constructing module serves to determine whether number of transactions initiated by an account satisfies a first predetermined condition, and if yes, execute a first lightening procedure on the transactions, and the transaction deleting module serves to execute a second lightening procedure on the transactions that have been processed in the first lightening procedure and now have validation references satisfying a second predetermined condition, after which the network broadcast module broadcasts the transactions obtained after the second lightening procedure.

2. The lightweight data storage apparatus of claim 1, wherein the combined-transaction constructing module is configured to periodically determine whether the number of the transactions initiated by the account satisfies the first predetermined condition for combination.

3. The lightweight data storage apparatus of claim 2 further comprising a common transaction construction module that serves to construct data of new transaction initiated by the user.

4. The lightweight data storage apparatus of claim 3, wherein the combined-transaction constructing module is for collecting at least one previous transaction prior to the construction of the new transaction and combining the collected at least one previous transaction with the recently constructed new transaction.

5. The lightweight data storage apparatus of claim 4, wherein the combined-transaction constructing module is configured to generate at least one of the followings for the combined transaction through the first lightening procedure: content site, header site, validation site, and signature site.

6. The lightweight data storage apparatus of claim 5, further comprising a content site compressing module, which serves to uniformly store the content sites in the different combined transactions associated with the same account.

7. The lightweight data storage apparatus of claim 6, wherein the apparatus is configured to combine validation references of individual transactions so as to construct a validation site in a combined transaction.

8. The lightweight data storage apparatus of claim 7, wherein the second predetermined condition includes: at least one transaction in the combined transaction has reached a reference override state.

9. The lightweight data storage apparatus of claim 8, wherein the apparatus is configured to delete validation reference data of transactions that have reached the reference override state.

10. The lightweight data storage apparatus of claim 9, wherein the apparatus is configured to have the account construct a common transaction, and broadcast the common transaction if the number of transactions initiated by an account does not satisfy the first predetermined condition.

11. A lightweight data storage method for graphic blockchains, the method at least comprising:
determining whether number of transactions initiated by an account satisfies a first predetermined condition;
executing a combining procedure on the transactions, when the number of transactions satisfies the first predetermined condition;
determining whether validation references of the transactions satisfy a second predetermined condition;
executing a deleting procedure on the transactions, when the validation references satisfy the second predetermined condition; and
broadcasting the combined transactions.

12. The lightweight data storage method of claim 11, wherein further comprising periodically determining whether the number of the transactions initiated by the account satisfies the first predetermined condition for combination.

13. The lightweight data storage method of claim 12, wherein the first predetermined condition includes: the current number of the transactions initiated by the account is an integer multiple of a predetermined threshold for the number of transactions.

14. The lightweight data storage method of claim 13, wherein further comprising combining at least two of the transactions initiated by the account corresponding to the predetermined threshold for the number of transactions and obtaining a combined transaction.

15. The lightweight data storage method of claim 14, wherein the step of combining transactions at least comprises: combining validation references of individual transactions so as to construct a validation site in a combined transaction.

16. The lightweight data storage method of claim 15, wherein the second predetermined condition includes: at least one transaction in the combined transaction has reached a reference override state.

17. The lightweight data storage method of claim 16, wherein the step of deleting transactions at least comprises: deleting validation reference data of transactions that have reached the reference override state.

18. The lightweight data storage method of claim 17, wherein if the number of transactions initiated by an account does not satisfy the first predetermined condition, the account constructs a common transaction, and broadcasts the common transaction.

19. A lightweight data storage apparatus applicable to graphic blockchains, which at least comprises a common transaction construction module for users to initiate new transactions, the apparatus further comprising:
a combined-transaction constructing module, being configured to collect at least one transaction initiated by the account previously, and combine relevant fields in the at least one transaction initiated by the account previously with relevant fields in a new transaction;
a reference override computing module, for computing override relationship of validation references contained in the new transaction; and
a transaction deleting module, for deleting transactions that have reached the reference override state.

20. The lightweight data storage apparatus applicable to graphic blockchains of claim 19, wherein the combined-transaction constructing module is configured to periodically determine whether the number of the transactions initiated by the account satisfies the first predetermined condition for combination.
